(19) United States
(12) Patent Application Publication
(10) Pub. No.: US 2017/0169572 A1
(43) Pub. Date: Jun. 15, 2017

(54) Method and electronic device for panoramic video-based region identification

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Fulun TAN, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/242,252

(22) Filed: Aug. 19, 2016

Related U.S. Application Data
(63) Continuation of application No. PCT/CN2016/089547, filed on Jul. 10, 2016.

(30) Foreign Application Priority Data
Dec. 15, 2015 (CN) 201510930068.4

(51) Int. Cl. G06T 7/00; G06T 3/20; G06K 9/52; G06K 9/00

(52) U.S. Cl. CPC G06T 7/0081; G06K 9/00744; G06T 7/004; G06T 3/20; G06K 9/52

(57) ABSTRACT

Disclosed a method and an electronic device for panoramic video-based region identification. The method includes: determining whether a characteristic region of a panoramic video in a current display page of a display screen; in a case in which the characteristic region is included in the current display page, determining whether a location of a current operation is in the characteristic region; and in a case in which the location of the current operation is in the characteristic region, triggering an event for the characteristic region. By means of the method and the electronic device, region identification can be determined conveniently, simply and accurately, and a disclosure of a panoramic video is better expanded.

### CROSS-REFERENCE TO RELATED APPLICATIONS

The present application is a continuation of PCT application No. PCT/CN2016/089547 submitted on Jul. 10, 2016, which is based upon and claims priority to Chinese Patent Application No. 2015109300684, filed on Dec. 15, 2015 and entitled “METHOD AND DEVICE FOR PANORAMIC VIDEO-BASED REGION IDENTIFICATION,” both of which are incorporated herein by reference in their entireties.

### TECHNICAL FIELD

The present disclosure relates to the field of panoramic videos, and specifically, to a method and an electronic device for panoramic video-based region identification.

### BACKGROUND

A panoramic video can convert a static panoramic image to a dynamic video image. The panoramic video may allow a dynamic video to be viewed at 360 degrees around a shooting angle, so that a user has an immersive feeling in a real sense, and it is not limited by time, space and a region. The panoramic video is not a single form of a static panoramic image, but all-inclusive and has depth of field, dynamic images, sound and the like, and has counterpoint of sound and picture and synchronization of sound and picture.

In some cases, a user may expect to place some advertisements in a panoramic video, or switch to a next scene on the basis of some tags in the panoramic video. In this case, region identification needs to be performed on the basis of the panoramic video.

### SUMMARY

On a first aspect, an embodiment of the present disclosure provides a panoramic video-based region identification method. The method includes: determining whether a characteristic region of a panoramic video in a current display page of a display screen; in a case in which the characteristic region is included in the current display page, determining whether a location of a current operation is in the characteristic region; and in a case in which the location of the current operation is in the characteristic region, triggering an event for the characteristic region.

On a second aspect, an embodiment of the present disclosure further provides a non-transitory computer-readable storage medium, which stores computer executable instructions that, when executed by an electronic device, cause the electronic device to perform any of the foregoing panoramic video-based region identification methods of the disclosure.

According to a third aspect, an embodiment of the disclosure further provides an electronic device, including: at least one processor; and a memory in communication connection with the at least one processor. The memory stores instructions that can be executed by the at least one processor, and the instructions is executed by the at least one processor, cause the at least one processor to perform any of the foregoing panoramic video-based region identification methods of the disclosure.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 shows a flowchart of a panoramic video-based region identification method according to an embodiment of the present disclosure;

FIG. 2 shows an interface view in which a spherical video source is converted to a viewing screen according to an embodiment of the present disclosure;

FIG. 3 shows a structural block diagram of a panoramic video-based region identification device according to an embodiment of the present disclosure; and

FIG. 4 is a schematic structural diagram of hardware of a device for executing a panoramic video-based region identification method according to an embodiment of the present disclosure.

List of Reference Numerals

| | |
|---|---|
| 100 Characteristic region | 200 Location determining module |
| determining module | |
| 300 Trigger module | 110 Coordinate conversion unit |
| 120 Coordinate determining unit | 210 Distance calculating unit |
| 220 Distance determining unit | |

### DETAILED DESCRIPTION

Specific embodiments of the present disclosure are described in detail with reference to accompanying drawings in the following. It should be understood that the specific embodiments described herein are only for the purpose of specifying and explaining the present disclosure and not intended to limit the present disclosure.

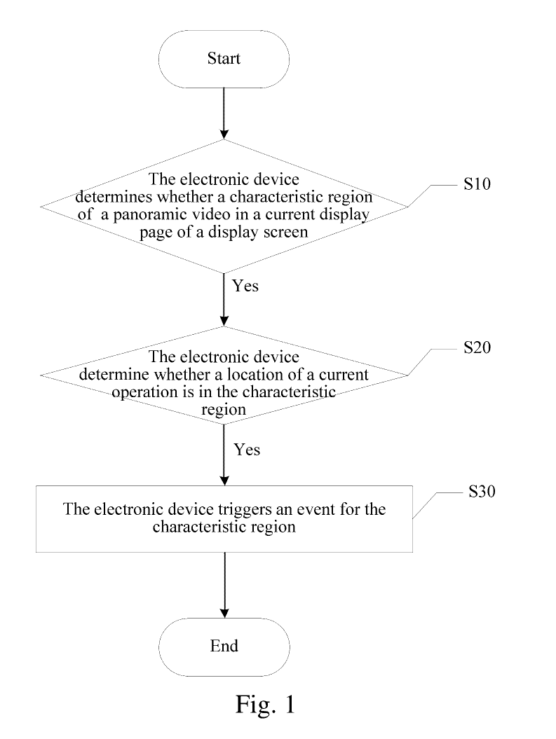

FIG. 1 shows a flowchart of a panoramic video-based region identification method according to an embodiment of the present disclosure. As shown in FIG. 1, the panoramic video-based region identification method provided by the present disclosure includes step S10 to step S30.

In step S10: whether a characteristic region of a panoramic video in a current display page of a display screen is determined.

The characteristic region may be some trademarks, animals, plants or landmark buildings or the like included in the panoramic video. One or more characteristic points may be tagged in the characteristic region of the panoramic video in advance. The one or more characteristic points are selected from one or more of the following: one or more edge points of the characteristic region, or a central point of the characteristic region. For example, for a dangling trademark, its top, bottom, left, right or central point may be selected as the characteristic point.

In an actual use, to play a shot two-dimensional panoramic video on a display screen, the two-dimensional panoramic video needs to be converted. The steps are as follows: (1) attaching an original two-dimensional video source to a three-dimensional spherical model to generate a spherical video source (which is equivalent to play the original two-dimensional panoramic video by attaching it to a spherical surface); (2) capturing a part of the spherical video source and project the part of the spherical video source onto a two-dimensional display screen; and (3) by flicking the screen, a user traversing different portions of the spherical surface to be able to view all views included in the panoramic video.

When whether the characteristic region is included in the current display page is determined, one or more characteristic points of the characteristic region are first tagged in the two-dimensional panoramic video, and coordinates of the one or more characteristic points in the two-dimensional panoramic video are recorded, and then coordinates (x1, y1) of the characteristic points in the two-dimensional panoramic video are converted to coordinates (x2, y2) of the characteristic points on the display screen. A coordinate plane in the two-dimensional panoramic video is measured in pixels. Assuming that a video resolution is 800*600, 0<x1<800, and 0<y1<600. The coordinates (x2, y2) on the screen are measured in pixels. If a screen resolution is 1920*1080, 0<x2<1920, 0<y2<1080. How the coordinates (x1, y1) in the two-dimensional panoramic video are converted to the coordinates (x2, y2) on the display screen is described in detail in the following.

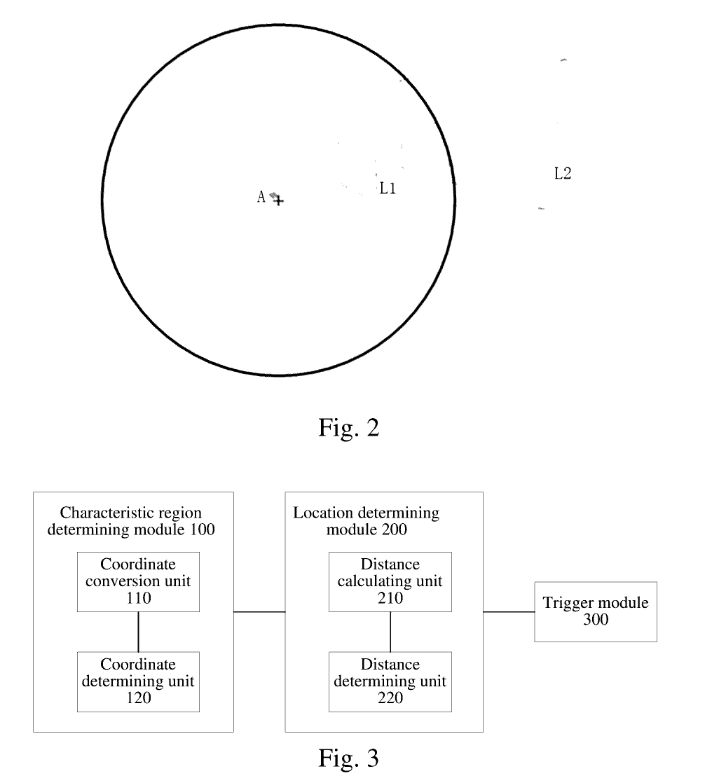

FIG. 2 shows an interface view in which a spherical video source is converted to a viewing screen according to an embodiment of the present disclosure. As shown in FIG. 2, a point A is a location of human eyes, that is, the location of the human eyes is at a center of a sphere, a plane L1 is a viewing screen, and a spherical video source is converted to an interface of the viewing screen according to the perspective projection theory. In FIG. 2, a plane L2 and the plane L1 (the viewing screen) are a far plane and a near plane according to the perspective projection theory, respectively. How to convert the spherical video source to the interface of the viewing screen belongs to common knowledge of the field of perspective projection, and are not described specifically herein.

Coordinates of the coordinate points (x1, y1) in the two-dimensional panoramic video may be represented by (x′, y′, z′) in the spherical video source, where (x′, y′, z′)=(x1,y1)*M1, M1 is a conversion matrix that converts coordinates in the original two-dimensional panoramic video to coordinates in the spherical video source, a matrix M1 belongs to the common knowledge of the art, and are not described repeatedly herein.

According to the perspective projection theory, a coordinate (x′, y′, z′) of the point in the spherical video source may be first converted to a view plane coordinate (x″, y″) by a conversion matrix M2, represented by (x″, y″)=(x′, y′, z′)*M2. In the present disclosure, the conversion matrix M2 is related to a perspective projection matrix, a location of a point in the spherical video source relative to a viewing location of the human eyes, and an angle of rotation of the sphere model of the spherical video source relative to the viewing location of the human eyes, represented by M2=M21*M22*M23, wherein M21 is a location matrix of points in the spherical video source relative to the viewing location of the human eyes, M22 is a rotation matrix of sphere models of the spherical video source relative to the viewing location of the human eyes, and M23 is a projection matrix. A view plane coordinate (x″, y″) of a point having a coordinate of (x1, y1) in the two-dimensional panoramic video may be represent by:

(x″, y″)=(x1, y1)*M1*M2,

The view plane coordinate (x″, y″) of the coordinate point (x1, y1) may be converted to a screen coordinate (x2, y2) by a conversion matrix M3, that is, (x2, y2)=(x1, y1)*M1*M2*M3. M3 is a matrix related to a display screen resolution, which can convert a view plane coordinate to a display screen coordinate.

In conclusion, conversion of the coordinate point (x1, y1) in the two-dimensional panoramic video to the coordinate (x2, y2) in the display screen may be implemented by a formula (1),

(x2, y2)=(x1, y1)*H, (1)

where H=M1*M2*M3, if the converted x2,y2 both satisfy a coordinate range of the display screen, the coordinate point (x1, y1) in the original panoramic video is definitely included in a current display page.

Moreover, whether a characteristic region is included in the current display page also may be determined by determining whether the view plane coordinate (x″, y″) satisfies a coordinate range of the view plane. Here, the coordinate range of the view plane may be set as a coordinate range of −1 to 1 on the x axis, and a coordinate range of −1 to 1 on the y axis. If after conversion, the view plane coordinate (x″, y″) satisfies −1<x″<1, and −1<y″<1, it indicates that the coordinate point (x1, y1) in the original panoramic video is included in a current display page.

Optionally, as long as one characteristic point is included in the display page, it may be considered that the characteristic region corresponding to the characteristic point is included in the current display page.

In step S20: in a case in which the characteristic region is included in the current display page, whether a location of a current operation is in the characteristic region is determined. Here, the location of the current operation may be a current placement location of a cursor or a finger on a screen.

Specifically, the determining whether a location of a current operation is in the characteristic region includes: calculating a distance between a coordinate location (X,Y) of a current operation and the one or more characteristic points (x2, y2) on the basis of the current display page. Optionally, the distance between the two may be calculated by their respective coordinates. For example, the distance between the two may be calculated according to a Euclidean distance, which may be represent by (X-x2)2+(Y-y2)2. Among the calculated distances between the location of the cursor or the finger and the one or more characteristic points, as long as one distance is less than a preset distance (measured in pixels), it may be determined that the location of the current operation is in the characteristic region. Optionally, the location of the current operation may be tagged by using the location of the cursor or the finger.

In step S30: in a case in which the location of the current operation is in the characteristic region, an event for the characteristic region is triggered. For example, if the characteristic region is a trademark, for the trademark, some product introductions corresponding to the trademark may be triggered or an advertisement video for the trademark may be triggered; and if the characteristic region is a landmark building, an introduction for the building may be triggered; or another scene may be switched to for the characteristic region, etc.

FIG. 3 shows a structural block diagram of a panoramic video-based region identification device according to an embodiment of the present disclosure. As shown in FIG. 3, correspondingly, the present disclosure further provides a panoramic video-based region identification device. The device includes: a characteristic region determining module 100 configured to determine whether a characteristic region of a panoramic video in a current display page of a display screen; a location determining module 200 configured to determine whether a location of a current operation is in the characteristic region in a case in which the characteristic region is included in the current display page; and a trigger module 300 configured to trigger an event for the characteristic region in a case in which the location of the current operation is in the characteristic region.

Optionally, a characteristic region determining module 100 includes: a coordinate conversion unit 110 configured to convert coordinates of one or more characteristic points tagged in the characteristic region of the panoramic video corresponding to the panoramic video to coordinates corresponding to the display screen; and a coordinate determining unit 120 configured to determine whether the coordinates of the one or more characteristic points corresponding to the display screen are included in a coordinate range of the display screen.

Optionally, the coordinate conversion unit 120 is further configured to convert the coordinates of the one or more characteristic points corresponding to the panoramic video to the coordinates corresponding to the current display page by the formula below: (x2, y2)=(x1, y1)*H, where (x2, y2) represents coordinates of the one or more characteristic points on the current display page, (x1, y1) represents coordinates of the one or more characteristic points in the panoramic video, and H represents a conversion matrix that converts coordinates in the panoramic video to coordinates on the display screen.

Optionally, the location determining module 200 further includes: a distance calculating unit 210 configured to calculate a distance between the location of the current operation and the one or more characteristic points on the basis of the current display page; and a distance determining unit 220 configured to determine that the location of the current operation is in the characteristic region in a case in which at least one of the calculated one or more distances is less than a preset distance.

Optionally, the one or more characteristic points are selected from one or more of the following: one or more edge points of the characteristic region, or a central point of the characteristic region.

The panoramic video-based region identification device provided by the present disclosure and the foregoing panoramic video-based region identification method share a similar operating principle, which is not described herein repeatedly.

The panoramic video-based method and device provided by the present disclosure can enable the panoramic video-based region identification to be determined conveniently, simply and accurately, and better expand an application of a panoramic video, so that a user can add some region identification-based applications to the panoramic video.

Correspondingly, an embodiment of this disclosure provides a non-transitory computer-readable storage medium, which stores computer executable instructions that, when executed by an electronic apparatus, cause the electronic apparatus to perform the panoramic video-based region identification method of any of the foregoing method embodiments of the disclosure.

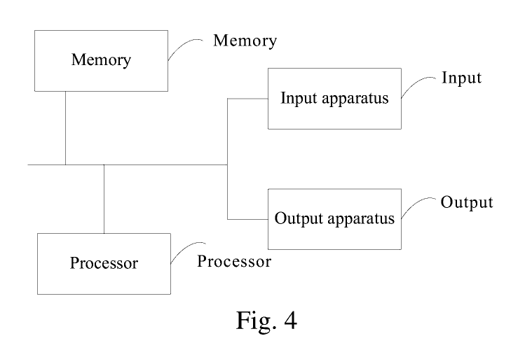

FIG. 4 shows a schematic structural diagram of hardware of a device for executing a panoramic video-based region identification method provided by an embodiment of the disclosure. As shown in FIG. 4, the device includes: one or more processors Processor and a memory Memory, with one processor Processor as an example in FIG. 4.

A device for executing the panoramic video-based region identification method may further include: an input apparatus Input and an output apparatus Output.

The processor Processor, the memory Memory, the input apparatus Input, and the output apparatus Output can be connected by means of a bus or in other manners, with a connection by means of a bus as an example in FIG. 4.

As a non-transitory computer-readable readable storage medium, the memory Memory can be used to store non-volatile software programs, non-transitory computer-readable executable programs and modules, for example, program instructions/module corresponding to the panoramic video-based region identification method in the embodiments of the disclosure (for example, a characteristic region determining module 100, a location determining module 200 and a trigger module 300 shown in FIG. 3). The processor Processor executes various functional applications and data processing of the server, that is, implements the panoramic video-based region identification method of the foregoing method embodiments, by running the non-transitory software programs, instructions, and modules stored in the memory Memory.

The memory Memory may include a program storage area and a data storage area, where the program storage area may store an operating system and at least one application needed by function; the data storage area may store data created according to use of a panoramic video-based region identification device, and the like. In addition, the memory Memory may include a high-speed random access memory, and also may include a non-transitory memory, such as at least one disk storage device, flash storage device, or other non-transitory solid-state storage devices. In some embodiments, the memory Memory optionally includes memories remotely disposed corresponding to the processor Processor, and the remote memories may be connected, via a network, to the panoramic video-based region identification device. Examples of the foregoing network include but are not limited to: the Internet, an intranet, a local area network, a mobile communications network, and a combination thereof.

The input apparatus Input can receive entered digit or character information, and generate key signal inputs relevant to user setting and functional control of the panoramic video-based region identification device. The output apparatus Output may include a display device, for example, a display screen, etc.

The one or more modules are stored in the memory Memory, and execute the panoramic video-based region identification method in any one of the foregoing method embodiments when being executed by the one or more processors Processor.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

What is claimed is:

1. A panoramic video-based region identification method applied in an electronic device, comprising:
determining whether a characteristic region of a panoramic video in a current display page of a display screen;
in a case in which a characteristic region is in the current display page, determining whether a location of a current operation is in the characteristic region; and
in a case in which the location of the current operation is in the characteristic region, triggering an event for the characteristic region.

2. The method according to claim 1, wherein the step of the determining whether a characteristic region in a current display page comprises:
converting coordinates of one or more characteristic points tagged in the characteristic region of the panoramic video corresponding to the panoramic video to coordinates corresponding to the display screen; and
determining whether the coordinates of the one or more characteristic points corresponding to the display screen is contained in a coordinate range of the display screen.

3. The method according to claim 2, wherein the coordinates of the one or more characteristic points corresponding to the panoramic video are converted to the coordinates corresponding to the display screen by the formula below:
(x2, y2)=(x1, y1)*H;
wherein (x2, y2) represents coordinates of the one or more characteristic points on the current display page, (x1, y1) represents coordinates of the one or more characteristic points in the panoramic video, and H represents a conversion matrix that converts coordinates in the panoramic video to coordinates on the display screen.

4. The method according to claim 2, wherein in a case in which the characteristic region is contained in the current display page, the determining whether a location of a current operation is in the characteristic region comprises:
calculating a distance between the location of the current operation and the one or more characteristic points on the basis of the current display page; and
in a case in which at least one of the calculated one or more distances is less than a preset distance, determining that the location of the current operation is in the characteristic region.

5. The method according to claim 2, wherein the one or more characteristic points are selected from one or more of the following: one or more edge points of the characteristic region, or a central point of the characteristic region.

6. A non-transitory computer-readable storage medium, stored with computer executable instructions that, when executed by an electronic device, cause the electronic device to:
determine whether a characteristic region of a panoramic video in a current display page of a display screen;
in a case in which a characteristic region is comprised in the current display page, determine whether a location of a current operation is in the characteristic region; and
in a case in which a location of the current operation is in the characteristic region, trigger an event for the characteristic region.

7. The non-transitory computer-readable storage medium according to claim 6, wherein the step of the determining whether a characteristic region is comprised cause the electronic device to:
convert coordinates of one or more characteristic points tagged in the characteristic region of the panoramic video corresponding to the panoramic video to coordinates corresponding to the display screen; and
determine whether the coordinates of the one or more characteristic points corresponding to the display screen is comprised in a coordinate range of the display screen.

8. The non-transitory computer-readable storage medium according to claim 8, wherein the coordinates of the one or more characteristic points corresponding to the panoramic video are converted to the coordinates corresponding to the display screen by the formula below:
(x2, y2)=(x 1, y1)*H;
wherein (x2, y2) represents coordinates of the one or more characteristic points on the current display page, (x1, y1) represents coordinates of the one or more characteristic points in the panoramic video, and H represents a conversion matrix that converts coordinates in the panoramic video to coordinates on the display screen.

9. The non-transitory computer-readable storage medium according to claim 8, wherein in a case in which the characteristic region is comprised in the current display page, the step of the determining whether a location of a current operation is in the characteristic region cause the electronic device to:
calculate a distance between the location of the current operation and the one or more characteristic points on the basis of the current display page; and
in a case in which at least one of the calculated one or more distances is less than a preset distance, determine that the location of the current operation is in the characteristic region.

10. The non-transitory computer-readable storage medium according to claim 8, wherein the one or more characteristic points are selected from one or more of the following: one or more edge points of the characteristic region, or a central point of the characteristic region.

11. An electronic device, comprising:
at least one processor; and
a memory in communication connection with the at least one processor, where the memory stores a program that can be executed by the at least one processor that, when the instructions are executed by the at least one processor, cause the at least one processor to:
determine whether a characteristic region is comprised by a panoramic video in a current display page of a display screen;
in a case in which the characteristic region is comprised in the current display page, determine whether a location of a current operation is in the characteristic region; and
in a case in which the location of the current operation is in the characteristic region, trigger an event for the characteristic region.

12. The electronic device according to claim 11, wherein the step of the determining whether a characteristic region is comprised in a current display page cause the at least one processor to:
convert coordinates of one or more characteristic points tagged in the characteristic region of the panoramic video corresponding to the panoramic video to coordinates corresponding to the display screen; and
determine whether the coordinates of the one or more characteristic points corresponding to the display screen is comprised in a coordinate range of the display screen.

13. The electronic device according to claim 12, wherein the coordinates of the one or more characteristic points corresponding to the panoramic video are converted to the coordinates corresponding to the display screen by the formula below:
(x2, y2)=(x1, y1)*H;
wherein (x2, y2) represents coordinates of the one or more characteristic points on the current display page, (x1, y1) represents coordinates of the one or more characteristic points in the panoramic video, and H represents a conversion matrix that converts coordinates in the panoramic video to coordinates on the display screen.

14. The electronic device according to claim 12, wherein in a case in which the characteristic region is comprised in the current display page, the step of the determining whether a location of a current operation is in the characteristic region cause the at least one processor to:
calculate a distance between the location of the current operation and the one or more characteristic points on the basis of the current display page; and
in a case in which at least one of the calculated one or more distances is less than a preset distance, determine that the location of the current operation is in the characteristic region.

15. The electronic device according to claim 12, wherein the one or more characteristic points are selected from one or more of the following: one or more edge points of the characteristic region, or a central point of the characteristic region.
